(19) United States
(12) Patent Application Publication
(10) Pub. No.: US 2013/0297378 A1
(43) Pub. Date: Nov. 7, 2013

(54) Real Estate Heat Map

(71) Applicant: Harrison Gregory Hong, New York, NY (US)

(72) Inventor: Harrison Gregory Hong, New York, NY (US)

(21) Appl. No.: 13/742,330

(22) Filed: Jan. 15, 2013

Related U.S. Application Data
(60) Provisional application No. 61/643,342, filed on May 6, 2012.

(51) Int. Cl. G06Q 50/16

(52) U.S. Cl. CPC G06Q 50/16; G06Q 30/0201
USPC 705/7.29

(57) ABSTRACT

Some embodiments provide a system for generating price maps. The system includes a data module for retrieving (1) data related to locations of real estate properties and (2) data related to prices of the real estate properties. The system also includes a contour generator for generating a contour map that includes several contours based on the data related to the locations of the real estate properties and the data related to the prices of the real estate properties. Each contour represents a set of real estate properties having prices within a defined range of values.

### CLAIM OF BENEFIT TO PRIOR APPLICATION

This application claims the benefit of U.S. Provisional Patent Application 61/643,342, filed May 6, 2012. U.S. Provisional Patent Application 61/643,342 is hereby incorporated by reference.

### BACKGROUND

Today, a large number of real estate search portals offer users information about the price of properties in a city or region. Typically, the price information is listings prices but can also be transactions prices. This price information is usually organized according to historical districts or neighborhoods in a given city. For instance, in New York City, the average prices of listings or transactions are reported according to neighborhoods or districts such as Midtown, Lower East Side, and Upper West Side. This type of reporting of prices by historical neighborhoods is ubiquitous across many real estate websites across the world.

Organizing average prices in this manner for different neighborhoods in a city has several disadvantages. First, there are many apartments or communities on the borders of neighborhoods that are not easily classified since they fall in between districts or neighborhoods. Second, many users care about price and less about neighborhoods per se. They want to know which places in the city are cheap or expensive irrespective of arbitrary or historical definitions of neighborhoods. Third, many cities are often changing with new neighborhoods quickly developing that are not easily captured by historical definitions.

### BRIEF SUMMARY

Some embodiments of the invention provide a novel method for generating a contour map based on values of real estate properties. In some embodiments, the generated contour map represents (1) locations of real estate properties and (2) values of the real estate properties. Different embodiments use different types of real estate price information to generate the contour map. Examples of types of real estate price information include listings (e.g., for sale, rental, etc.), transactions, predicted price information generated from models, or any other type of data that represents the values of real estate properties. In some embodiments, the method generates a contour map of real estate prices for a geographic region (e.g., a city, a neighborhood, a county, a town, a state, a country, etc.). A contour map generated based on values of real estate properties is referred to as a price map in this application.

The contour map of some embodiments includes several contours. Each contour represents a particular price gradient (e.g., a defined range of price values). The method of some embodiments generates the contour map according to a set of rules that specifies a set of defined price gradients. In some instances, the contour map may include several contours that represent the same or similar price gradient and/or several contours that represent different price gradients. In some embodiments, contours that represent the same or similar price gradients have the same or similar appearances (e.g., using the same or similar color(s) to represent the same or similar contours).

In some embodiments, different contours of the contour map that represent different price gradients have different appearances. For instance, the method of some embodiments generates the different contours of the contour map that represent different price gradients using different colors. In some embodiments, the method uses additional and/or different types of indicators (e.g., hatch marks, highlights, etc.) for visually differentiating the different contours of the contour map that represent different price gradients. For example, the amount of hatch marks or the brightness of a contour indicates the level of the price gradient represented by the contour.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawing, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIG. 1 conceptually illustrates a software architecture of a price map generator of some embodiments.

FIG. 2 conceptually illustrates a process of some embodiments for generating a price map.

FIG. 3 conceptually illustrates an example price map.

FIG. 4 conceptually illustrates an example GUI that includes a portion of the price map illustrated in FIG. 3.

FIG. 5 conceptually illustrates a street map of the area of the price map illustrated in FIG. 4.

FIG. 6 conceptually illustrates the GUI illustrated in FIG. 4 that includes a transparent version of the price map illustrated in FIG. 4 superimposed over the street map illustrated in FIG. 5.

FIG. 7 conceptually illustrates an example GUI that shows results of a real estate search query.

FIG. 8 conceptually illustrates a software architecture of a real estate search system of some embodiments with the real estate heat map.

FIG. 9 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a novel method for generating a contour map based on values of real estate properties. In some embodiments, the generated contour map includes a set of contours that represent (1) locations of real estate properties and (2) values of the real estate properties. Different embodiments use different types of real estate price information to generate the contour map. Examples of types of real estate price information include listings (e.g., for sale, rental, etc.), transactions, predicted price information generated from models, or any other type of data that represents the values of real estate properties. In some embodiments, the method generates a contour map of real estate prices for a geographic region (e.g., a city, a neighborhood, a county, a town, a state, a country, etc.). A contour map generated based on values of real estate properties is referred to as a price map in this application.

As noted above, the contour map of some embodiments includes a set of contours. In some embodiments, a contour is a region or area of the contour map that represents a particular price gradient (e.g., a defined range of price values). The real estate properties located in the contour have prices that fall within the price gradient. In some embodiments, a contour is a planar figure where, for any two points within the contour, a path exists that runs within the contour from one point to the other point. In other words, for any two points within the contour, a line can be drawn within the contour that connects one point to the other point.

The method of some embodiments generates the contour map according to a set of rules that specifies a set of defined price gradients. In some instances, the contour map may include several contours that represent the same or similar price gradient and/or several contours that represent different price gradients. In some embodiments, different contours of the contour map that represent different price gradients have different appearances. For instance, the method of some embodiments generates the different contours of the contour map that represent different price gradients using different colors. In some embodiments, the method uses additional and/or different types of indicators (e.g., hatch marks, highlights, etc.) for visually differentiating the different contours of the contour map that represent different price gradients. For example, the amount of hatch marks or the brightness of a contour indicates the level of the price gradient represented by the contour.

In some embodiments, the method adjusts the contours of the contour map after generating the contour map. For example, the method of some embodiments modifies the colors used to differentiate different contours that represent different price gradients. In some embodiments, the method adjusts the contours of the contour map according to a set of rules that specifies the different colors to use for the appearances of contours that represent different price gradients. In this manner, contours that represent the same or similar price gradient across different price maps for different geographic regions have the same appearance.

The price map of some embodiments provides several features and/or advantages. For instance, the contours of the price map provide visual indications of the peaks (e.g., areas with higher priced properties) and valleys (e.g., areas with lower priced properties) of real estate property prices in a geographic region. This way, users can visualize areas with expensive properties, areas with cheap properties, and areas with properties priced in between.

In some instances, some of the contours of a price map are arranged as one or more groups of overlapping shapes (e.g. circles, ovals, ellipses, squares, octagons, non-polygon shapes, etc.) and/or blobs in a geographic region. In some embodiments, a blob is an amorphous shape. Additionally, a blob of some embodiments is an indistinct shapeless form. Using a city as an example, some contours of the price map for the city are arranged as groups of overlapping shapes and/or blobs near the center of the city and/or various business districts within the city (e.g., financial district, entertainment district, government district, technology district, etc.). The shapes and/or blobs that have few or no shapes and/or blobs overlapping them represent regions of the map that have higher priced real estate properties. In contrast, the shapes and/or blobs that have a large amount or all shapes and/or blobs overlapping them represent regions of the map that have lower priced real estate properties.

In some embodiments, the contours of a price map are represented by dashed lines. The “elevation” of a particular contour is indicated by a number associated with the dashed line that represents the particular contour. The most expensive area of the price map, which may be at a particular location in the city (e.g., near the center of the city), is depicted in some embodiments as the innermost contour of the price map. This contour is represented by a region enclosed by the dashed line that defines the contour. The average price of the real estate properties (e.g., apartments) within this contour is displayed near or around the dashed line that defines the contour's enclosed region. Other contours of the price map are also represented by dashed lines and indicated with corresponding price elevations near or around the respective contours. In some instances, contours of the price map farther from the particular location in the city are larger (i.e., have larger areas or regions). In other words, the area of the region enclosed by the dashed line of a particular contour increases as the distance of the defining dashed line from the particular location in the city increases. While the above explanation describes contours defined by dashed, additional and/or other types patterns for defining contours may be used in other embodiments (e.g., solid lines, dotted lines, etc.).

In some embodiments, a stand-alone application utilizes the method to illustrate prices of properties or average prices of properties in a geographic region. In other embodiments, a real estate search engine uses the method that display search results of apartment listings based on user input for certain search criteria over the price map.

While some examples and embodiments in this application describe contour maps that graphically represent the location of real estate properties and a value attribute (e.g., price) of the real estate properties, one of ordinary skill in the art will understand that other types the contour maps of some embodiments may graphically represent the location of real estate properties along with other attributes, characteristics, properties, etc., of the real estate properties. For example, in some embodiments, the contour maps graphically represent the location of real estate properties and a quality attribute associated with the real estate properties, a size attribute of the real estate properties, etc., or any combination of different types of attributes of the real estate properties.

In addition, one of ordinary skill in the art will realize that the examples and embodiments may be applicable to additional and/or other types of real estate property described in this application. For example, the techniques described in this application may be applicable to houses, condos, apartments (e.g., individual apartments in an apartment building), apartment buildings, hotels, hotel rooms, office buildings, etc.

Several more detailed embodiments of the invention are described in the sections below. Section I describes details of generating price maps according to some embodiments of the invention. Next, Section II describes the software architecture of a real estate search system of some embodiments. Finally, Section III describes an electronic system that implements some embodiments of the invention.

### I. Price Map Generation

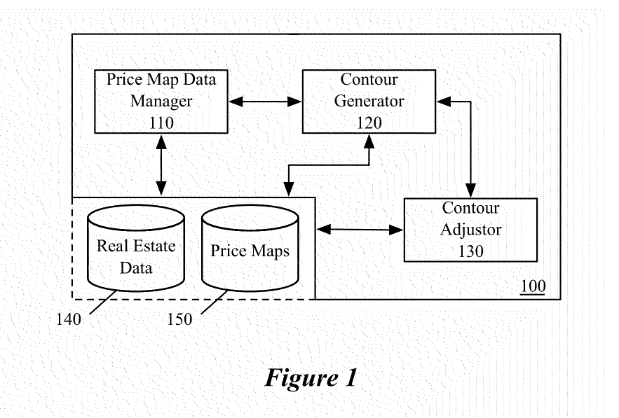

FIG. 1 conceptually illustrates a software architecture of a price map generator 100 of some embodiments. As illustrated in this figure, the price map generator 100 includes a price map data manager 110, a contour generator 120, and a contour adjustor 130. FIG. 1 also shows a real estate data storage 140 for storing real estate data and a price maps storage 150 for storing price maps.

In some embodiments, the real estate data storage 140 stores different types of data related to real estate. For instance, the real estate data storage 140 may store data related to the locations of real estate (e.g., latitude and longitude coordinates), data related to the values of real estate, or any other type of data related to real estate. Examples of data related to the values of real estate include for-sale listing prices, transaction prices of previous sale(s), rental listing prices, transaction prices of previous rental(s), prices of real estate predicted using real estate models, average prices of apartments in apartment buildings, etc. In some embodiments, the data storages 140 and 150 are implemented as one physical storage. In other embodiments, the real estate data and the price maps are stored in separate physical storages.

The price map data manager 110 is responsible for identifying the data that is used to generate price maps. The price map generator 100 of some embodiments uses (1) the values of properties and (2) the location of the properties to generate a price map. In some such embodiments, the price map data manager 110 identifies the data that is used to generate a price map in the real estate data storage 140. The price map data manager 110 of some embodiments retrieves the identified data from the real estate data storage 140 and sends the data to the contour generator 120. Still, in some embodiments, the price map data manager 110 instructs the contour generator 120 to retrieve the identified data from the real estate data storage 140.

The contour generator 120 handles the generation of contour maps. In some embodiments, a price map is a contour map that graphically represents on the map (1) locations of properties and (2) prices of the properties. When the contour generator 120 receives the values of the properties and the location data of the properties, the contour generator 120 generates a contour map that graphically represents on the map the locations of the properties and the prices of the properties. In some embodiments, the contour generator 120 uses a third party tool (e.g., Surfer 100, provided by Golden Software, or Maptiler) for generating the contour map. The contour map generator 120 sends the generated contour map to the contour adjustor 130 after the contour map is generated.

In some embodiments, the contour adjustor 130 adjusts contour maps generated by the contour generator 120. When the contour adjustor 130 receives a contour map from the contour generator 120, the contour adjustor 130 performs a variety of adjustments to the contour map. For instance, the contour adjustor 130 may change or modify the colors that are used to identify the different contours of the contour map, adjust the price levels of the contours of the contour map, etc. The contour adjustor 130 of some embodiments adjusts the contour map based on a defined set of rules. In some embodiments, the contour adjustor 130 uses a third party tool (e.g., Surfer 100, provided by Golden Software, or Maptiler) for adjusting the contour map. After the contour adjustor 130 is finished adjusting the contour map, the contour adjustor 130 stores the contour map in the price maps storage 150 for later use in a graphical user interface (GUI) (e.g., a GUI for real estate search). Instead of generating a price map for later use, the price map generator 100 of some embodiments generates price maps on-the-fly in response to requests for price maps. For example, the price map generator 100 may receive a request from a real estate search engine to generate a price map for a particular geographical region on which the real estate search engine is searching.

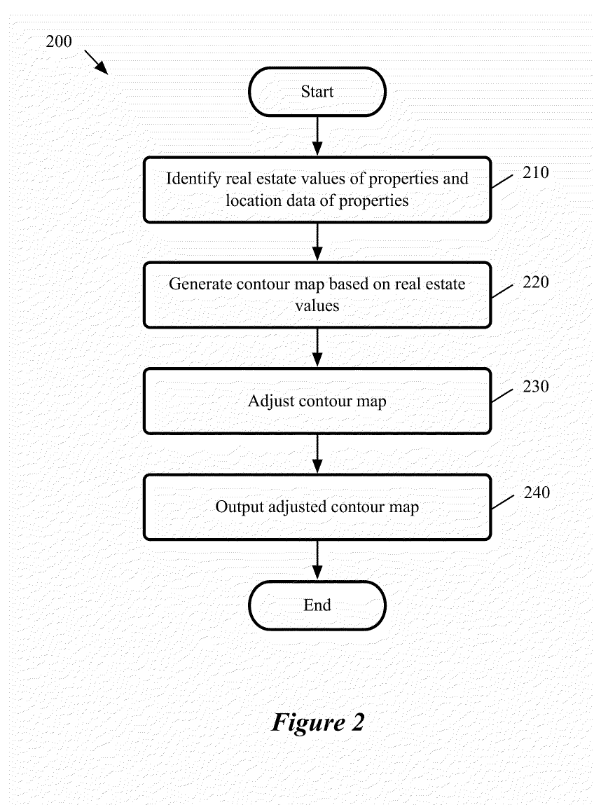

The operation of the price map generator 100 will now be described by reference to FIG. 2, which conceptually illustrates a process 200 of some embodiments for generating a price map. The process 200 begins by identifying (at 210) the real estate values of properties and the location data of the properties that will be used to generate a price map. The price map data manager 110 of some embodiments identifies the real estate values and the location data of the properties from the real estate data storage 140. In some embodiments, the price map data manager 110 retrieves the identified data and sends it to the contour generator 120 while, in other embodiments, the price map data manager 110 instructs the contour generator 120 to retrieve the identified data from the real estate data storage 140.

Next, the process 200 generates (at 220) a contour map based on the identified real estate values of the properties and the location data of the properties. In some embodiments, the process 200 uses a third party tool (e.g., Surfer 100, provided by Golden Software) for generating the contour map. The contour map generator 120 of some embodiments performs the generation of the contour map. Once the contour map is generated, the contour map generator 120 sends the generated contour map to the contour adjustor 130.

The process 200 then adjusts (at 230) the generated contour map. In some embodiments, the process 200 uses a third party tool (e.g., Surfer 100, provided by Golden Software) for adjusting the contour map. The contour adjustor 130 of some embodiments performs the adjustment of the contour maps. The process 200 of some embodiments may adjust the contour map any number of different ways. For example, in some embodiments, the process 200 changes or modifies the colors that are used to identify the different contours of the contour map, adjusts the price levels of the contours of the contour map, etc.

In some embodiments, the process 200 adjusts the contour map based on a defined set of rules. The set of rules of some embodiments specifies a set of contour map adjustment operations to perform on the generated contour map to adjust the contour map according to a defined format. For instance, in some embodiments, the defined set of rules specifies that the highest price level of contours is colored red, the second highest price level of contours is color orange, the third highest price level of contours is colored yellow while the lowest price level contours is colored dark blue, the lowest price level contours is colored royal blue, and the lowest price level contours is colored light blue. In other words, the areas of the map with high prices are represented by warmer colors (e.g., red, orange, yellow) while the areas of the map with low prices are represented by cooler colors (e.g., dark blue, royal blue, light blue).

Finally, the process 200 outputs (at 240) the adjusted contour map. In some embodiments, the process 200 outputs the adjusted contour map by storing the contour map in a data storage for use at a later time (e.g., use in a GUI for real estate search). The contour adjustor 130 of some embodiments performs the outputting of the adjusted contour map. The process 200 of different embodiments outputs the adjusted contour map in different formats. In some embodiments, the process 200 outputs the adjusted contour as an image (e.g., a JPEG file, a TIFF file, etc.). In some cases, the process 200 may output the adjusted contour as a file that includes instructions for rendering the contour map (e.g., a keyhole markup language (KML) file). Still, the process 200 of some embodiments outputs the contour map in additional and/or other formats as well.

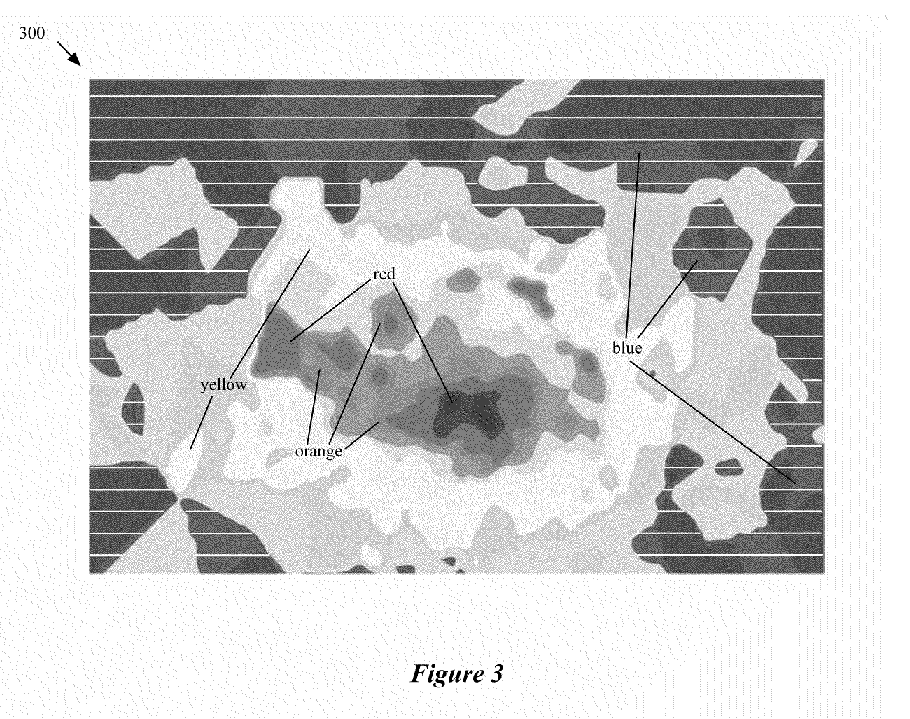

FIG. 3 conceptually illustrates an example price map 300 that is generated according to some embodiments of the invention. For this example, the contours with higher priced properties are colored with “warmer” colors (e.g., yellow, orange, red, etc.) while the contours with lower priced properties are colored with “cooler” colors (i.e., different shades of blue). In this example, the blue contours in the price map 300 are indicated by white horizontal lines. Thus, the blue contours represent areas of properties with low prices, the yellow contours represent areas of properties with medium prices, and the red contours represent areas of properties with high prices.

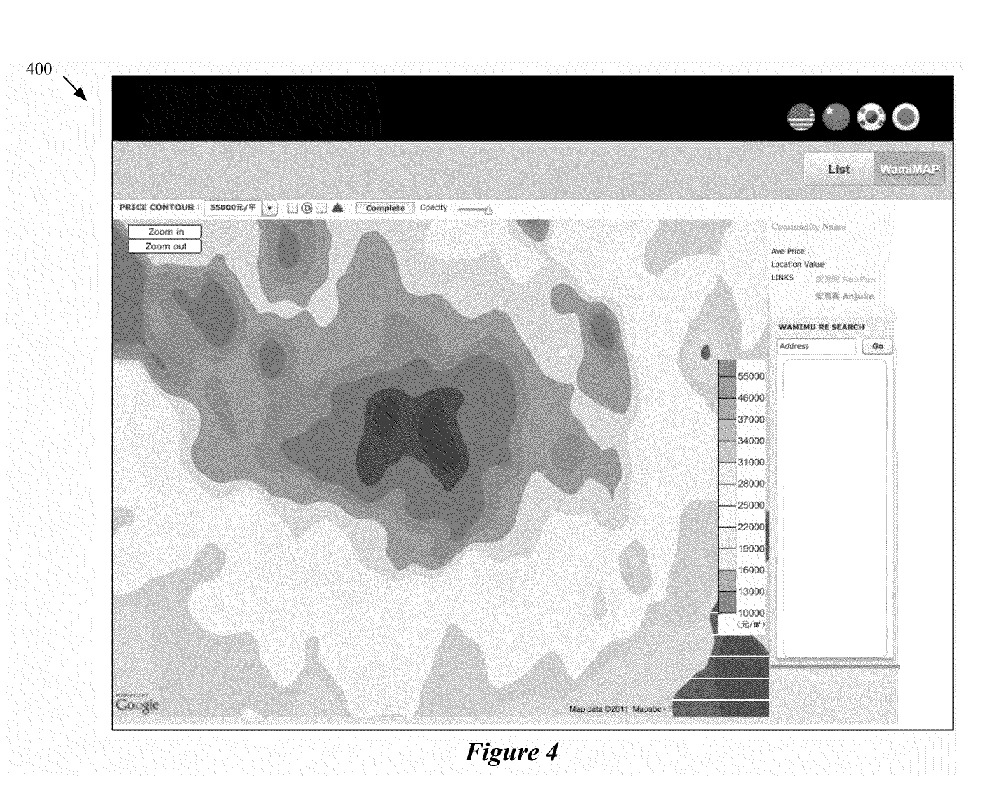

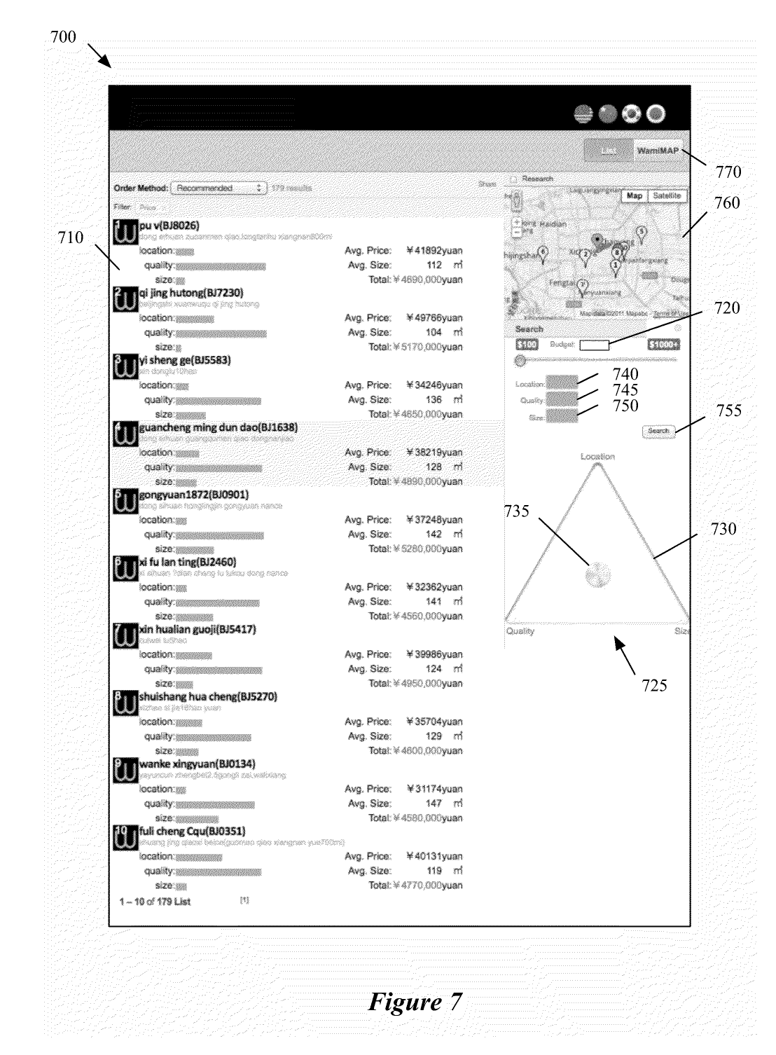

FIG. 4 conceptually illustrates an example GUI 400 that includes a portion of the price map 300. Specifically, the GUI 400 includes the portion near the center of the price map 300. In some embodiments, the GUI 400 is displayed when a selectable UI item of a GUI (e.g., selectable UI item 770 in GUI 700 of FIG. 7, which is described below) that provides the price map 300 is selected (e.g., through a cursor control operation such as clicking a mouse button, tapping a trackpad, or touching a touchscreen). The GUI 400 of some embodiments is displayed in response to a processing of a search query for real estate properties.

In some embodiments, the price map and the corresponding street map of the area of the price map are displayed together in a manner that is referred to as an overlay. For instance, some embodiments overlay the price map on the corresponding street map by overlaying the price map on top of a base layer of the street map and then overlaying an address layer of the street map on top of the price map. Some embodiments overlay the price map over both the address layer and the base layer of the street map by superimposing a transparent version of the price map over the address and base layers of the street map to show the correlation between the contour areas of the price map with the areas in the street map. By overlaying the price map over the corresponding street map, the price map provides visual identification of different regions of the geographic area with real estate properties having prices that fall within different price ranges (e.g., regions that are expensive, regions that are cheap, etc.). The following figures illustrate one method for overlaying a transparent version of a price map on top of a street map. However, additional and/or different methods may be utilized in other embodiments.

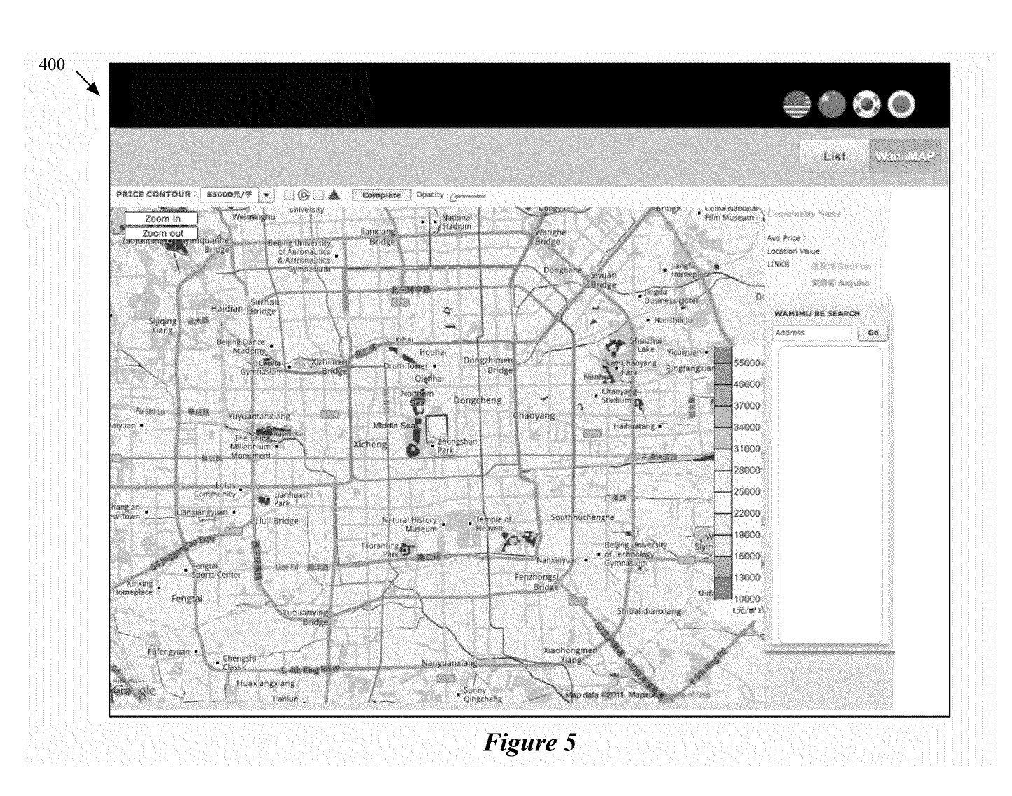

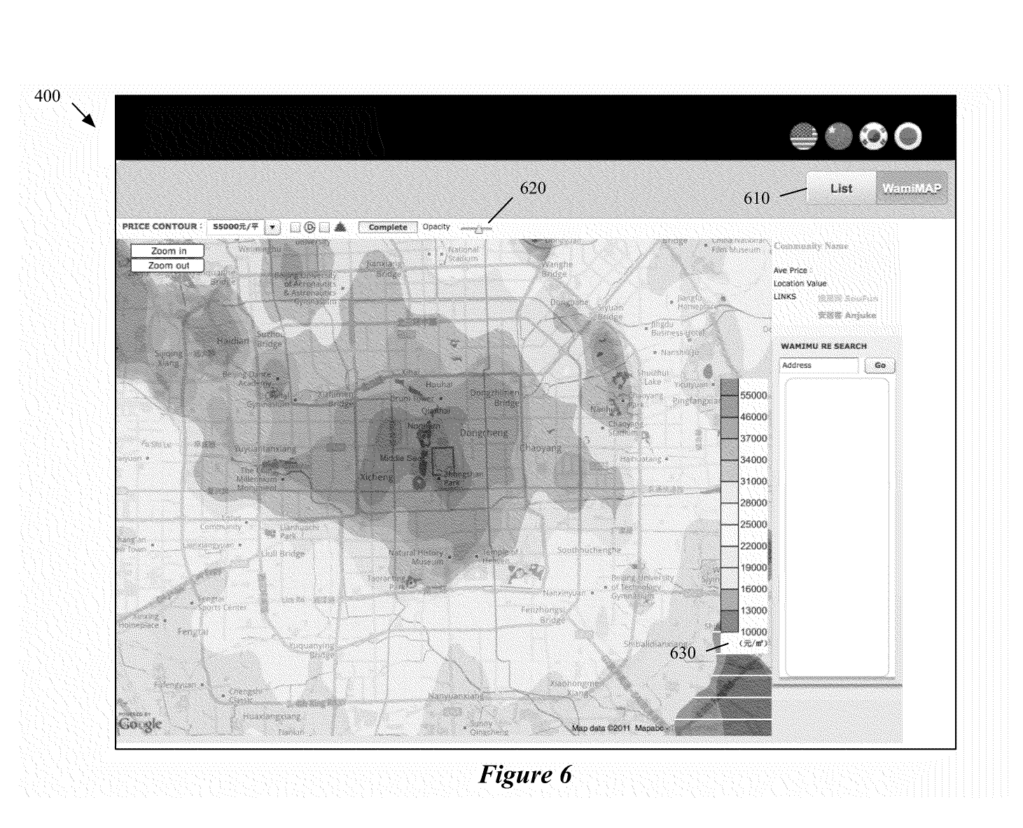

As shown, FIG. 5 conceptually illustrates a street map of the area of the price map illustrated in FIG. 4. FIG. 6 conceptually illustrates the GUI 400 that includes a transparent version of the price map illustrated in FIG. 4 superimposed over the street map illustrated in FIG. 5. As shown in FIG. 6, the GUI 400 includes a selectable UI item 610 and a slider control 620. The selectable UI item 610 is for displaying a list-view of the real estate properties identified from a search query. One example of such a list-view is illustrated in GUI 700 of FIG. 7.

As shown, the GUI 700 includes a list of real estate properties 710 that resulted from a real estate search query, an adjustable attribute weight selection control 725 that includes a selection area 730 and an attribute weight selector 735, a set of attribute weight indicators 740-750, selectable UI item 750, and a map display area 760.

The adjustable attribute weight selection control 725 is for specifying requested weights for each attribute in a set of property attributes. As shown, in this example, the adjustable attribute weight selection control 725 is for specifying weights for a location attribute, a size attribute, and a quality attribute. The adjustable attribute weight selection control 725 includes a selection area 730 and an attribute weight selector 735 that is movable within the selection area 730. The attribute weights associated with the adjustable attribute weight selection control 725 are specified based on the position of the attribute weight selector 735 in the selection area 730.

Conceptually, the adjustable attribute weight selection control 725 is for specifying amounts of a budget (e.g., the value specified in the UI text input item 720) to “spend” on different attributes when searching for properties. That is, the adjustable attribute weight selection control 725 is for specifying a portion of the value specified in the UI text input item 720 for each attribute in the set of property attributes based on the position of the attribute weight selector 735 in the selection area 730. For example, if a budget of 600 is specified in the UI text input item 720 and the attribute weight selector 735 is positioned in center of the selection area 730, 200 is allocated to each attribute. As another example, if 600 is specified in the UI text input item 720 and the attribute weight selector 735 is positioned all the way towards the vertex of the selection area 730 that corresponds to the quality attribute (i.e., the lower left vertex of the selection area 730), the entire 600 is allocated to the quality attribute and nothing is allocated to the location attribute and the size attribute.

The set of attribute weight indicators 740-750 each graphically represents the amount of a corresponding attribute weight based on the position of the attribute weight selector 735 in the selection area 730. In some embodiments, the GUI 700 adjusts the attribute weight indicators 740-1550 in real-time, in response to the positioning of the attribute weight selector 735 in the selection area 730. In this manner, the attribute weight indicators 740-750 provide visual feedback of the amount of each attribute weight relative to other attribute weights. That is, the attribute weight indicators 740-750 collectively display the relative distribution of attribute weights among the attributes.

The selectable UI item 755 (e.g., the Search button) is for initiating a search query for properties based on parameters specified by the selectable UI item 710, the UI input text item 720, and the adjustable attribute weight selection control 725. In some embodiments, the search query specifies to search for properties that (1) have the same or similar price as the value specified by the UI input text item 720 and (2) have the same or similar distribution of attribute weights as the attribute weights specified by the adjustable attribute weight selection control 725. When the GUI 700 receives a selection of the UI item 755 (e.g., through a cursor control operation such as clicking a mouse button, tapping a trackpad, or touching a touchscreen), the GUI 700 sends the search query to a real estate search engine of some embodiments to process the search request. When the GUI 700 receives the results of the search query from the real estate search engine, the GUI 700 displays the results in the same or similar location in which the set of properties 710 are displayed in FIG. 7.

The map display area 760 displays a map of the area that includes the properties in the set of properties 710. In this example, the map display area 760 displays a street map of the area that includes the properties in the set of properties 710. In some embodiments, the map display area 760 displays a price map of the area that includes the properties in the set of properties 710. Still, in some embodiments, the map display area 760 displays the above-mentioned street map overlaid with a transparent version of the above-mentioned price map. The map display area 760 displays other types of maps in some embodiments.

As shown, the set of properties 710 includes the 10 highest ranked properties out of 179 properties that resulted from the search. In some embodiments, the set of properties 710 includes a defined number (e.g., 10, 20, 25, 50, 100, etc.) of the highest ranked properties. In other embodiments, the set of properties 710 includes a defined percentage (e.g., 5 percent, 10 percent, 20 percent, etc.) of the highest ranked properties. In this example, these search results correspond to requested weight attributes that weighs more quality and less of location and size.

Details related to real estate search and graphical user interfaces for real estate search are described in U.S. patent application Ser. No. 13/400,067, filed Feb. 18, 2012, entitled “Real Estate Search Engine”, and U.S. patent application Ser. No. 13/400,068, filed Feb. 18, 2012, entitled “Graphical User Interface for Real Estate Search”. These applications are herein incorporated by reference.

The slider control 620 is for specifying a level of transparency (or opacity) for the price map to be displayed in the GUI 400. As shown, the slider control 620 includes a sliding region and slider that is moveable along the sliding region. Different locations along the sliding region correspond to different levels of transparency for the price map. The slider is for specifying a transparency level for the price map that corresponds to a location along the slider region that is indicated by the slider. In this example, the left side of the sliding region corresponds to high transparency levels (e.g., as shown in FIG. 5) and the right side of the sliding region corresponds to low transparency levels (e.g., as shown in FIG. 4). While a slider control is shown in FIG. 6, additional and/or different UI controls are included in the GUI of some embodiments. For instance, in some embodiments, the GUI includes a text field for entering a value that specifies a transparency level for the price map.

In many of the figures described above, colors are used to represent different regions with different prices ranges. In some embodiments, additional and/or other representations may be used in other embodiments. For instance, in some embodiments, a topography layout that includes regions and subregions of various shapes and size is used to represent the different regions of real estate properties with prices that fall within different price ranges. In some embodiments, a subregion within a region represents real estate properties that have prices that are higher than the prices of real estate properties located inside the region but outside the subregion.

The above-described figures illustrate price maps that include purely two-dimensional contours. In some embodiments, however, the topographical layout is represented as several three-dimensional or three-dimensional-like contours. For example, the price map of some embodiments is a topographic map that displays the horizontal and vertical dimensions of a geographic area that corresponds to the price map. However, in such embodiments, instead of representing the elevation of the land, the vertical dimension of the topographic map represents the prices of real estate properties. As such, the “elevation” of a particular region of the price map of such embodiments indicates that the particular region includes real estate properties that have prices that fall within a price range associated. Thus, the higher elevation regions (i.e., the peaks) of the topological layout represent the higher priced real estate properties located within the region, while the lower elevation regions (i.e., the valleys) of the topological layout represent the lower priced real estate properties located within the region. In this manner, the price map of such embodiments visually shows the peaks and valleys of the price map that correspond to areas with higher priced real estate properties and areas with lower priced properties, respectively. Additional and/or other methods of illustrating three-dimensional contours are possible (e.g., relief maps, shaded relief maps, three-dimensional contour maps, etc.)

### II. Use of Heat Map in an Example Real Estate Search System

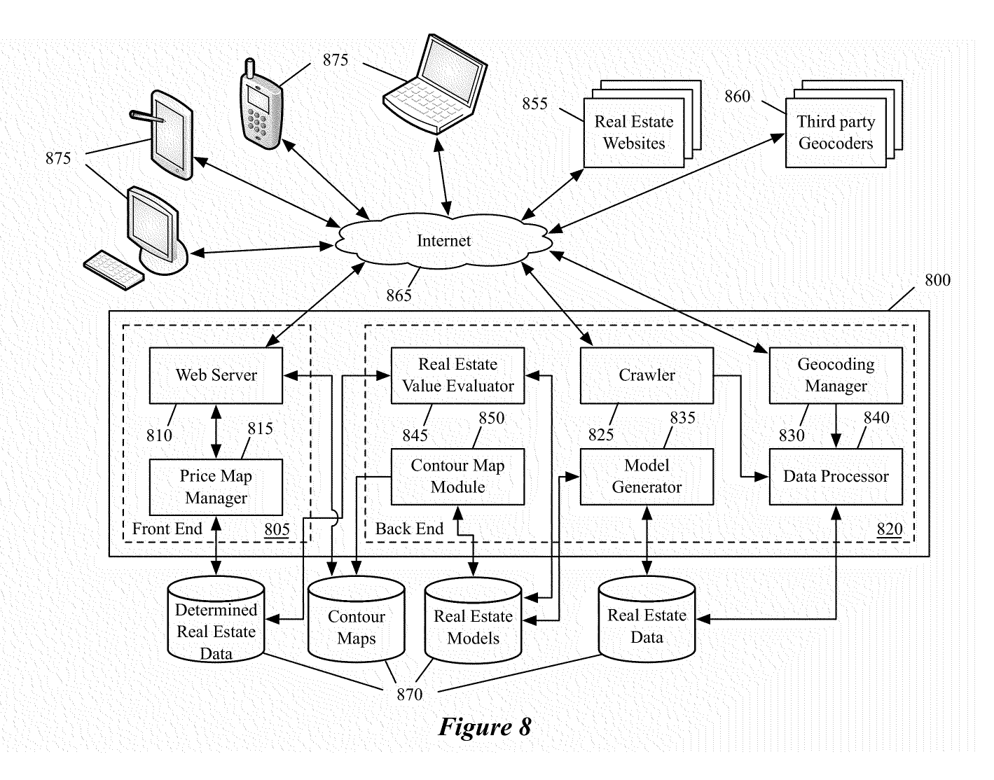

FIG. 8 conceptually illustrates a software architecture of a real estate search system 800 of some embodiments. As shown, the real estate search system 800 includes a front end 805 and a back end 820. FIG. 8 also illustrates data storages 870, devices 875, the Internet 865, real estate websites 855, and third party geocoders 860. In some embodiments, the data storages 870 are implemented as one physical storage. In other embodiments, the data storages 870 are implemented as separate storages. Still, in some embodiments, some of the data storages 80 are implemented as one physical storage and some of the data storages are implemented as separate storages. In some embodiments, the front 805 and the back end 820 are implemented on the same set of computing devices (e.g. servers, desktop computers, etc.) while, in other embodiments, the front 805 and the back end 820 are implemented on the separate sets of computing devices.

The back end 820 of the system 800 handles the different aspects of the data processing of the system 800. As shown, the back end 820 includes a crawler 825, a geocoding manager 830, a model generator 835, a data processor 840, a real estate value evaluator 845, and a contour map module 850.

The crawler 825 is a tool for crawling sources of data to retrieve data from the sources of data. In this example, the crawler 825 crawls real estate websites 855 through the Internet 865. The real estate websites 855 include real estate websites, public real estate records websites, sale and/or rental listings website, or any other websites that have real estate data or data related to real estate. In some embodiments, the crawler 825 uses any of the numerous third party crawling tools to crawl the Internet 865 for real estate data contained in the real estate websites 855. The crawler 855 of some embodiments crawls a defined list of websites. In some embodiments, the crawler 855 passes the real estate data obtained from the real estate websites 855 to the data processor 840. In other embodiments, the crawler 855 stores the real estate data in the real estate data storage for later processing by the data processor 840.

The geocoding manager 830 determines the location of real estate by using the third party geocoders 860 through the Internet 865. The third part geocoders 860 may be a website, a web-based service, an API, etc. When the geocoding manager 830 determines the location of real estate, the geocoding manager 830 of some embodiments sends the data to the data processor 840. In some embodiments, the geocoding manager 830 stores the data in the real estate data storage for later processing by the data processor 840.

The data processor 840 processes the real estate data retrieved by the crawler 825 and the location data obtained by the geocoding manager 830. Once the data processor 840 processes the real estate data, the data processor 840 stores the data in the real estate data storage.

The model generator 835 generates real estate models based on the real estate data processed by the data processor 840. The model generator 835 retrieves the processed data from the real estate data storage to generate real estate models. The model generator 835 stores the generated real estate models in the real estate models storage.

The real estate value evaluator 845 uses the real estate models generated by the model generator 835 to determine values of properties. In some embodiments, the real estate value evaluator 845 retrieves the real estate models that will be used to determine values of properties from the real estate models storage. The real estate value evaluator 845 of some embodiments stores the determined values in the determined real estate data storage.

The contour map module 850 is responsible for generating price maps based on values of properties determined using real estate models and the location data of the properties. In some embodiments, the contour map module 850 retrieves the data from the determined real estate data storage and the real estate data storage. After the contour map module 850 generates a price map, the contour map module 850 stores the price map in the contour maps storage. In some embodiments, the model generator 835 is implemented as the price map generator described above by reference to FIG. 1.

The front end 805 of the system 800 is responsible for facilitating the search for properties based on the determined values of properties determined by the back end 820. As shown, the front end 805 includes a web server 810 and a price map manager 815.

The web server 810 allows the devices 875 to search for properties through the Internet 865. The web server 810 may provide the search function through a webpage (e.g., such as the GUI 700), a web service, an application programming interface (API), etc. The web server 810 additionally processes the search queries that the web server 810 receives from the devices 875 through the Internet 865.

The price map manager 815 manages the price maps for display in GUIs, such as the GUI 400 illustrated in FIGS. 4-6. In some embodiments, the price map manager 815 retrieves the appropriate price map and the corresponding street map from the contour maps storage and passes the maps to the web server 810 for the web server 810 to provide to the devices 875 for display on the devices 875.

While many of the features have been described as being performed by one module (e.g., the web server 810), one of ordinary skill in the art will recognize that the functions described herein might be split up into multiple modules. Similarly, functions described as being performed by multiple different modules might be performed by a single module in some embodiments (e.g., the price map manager 815 and the contour map module 850).

### III. Electronic System

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

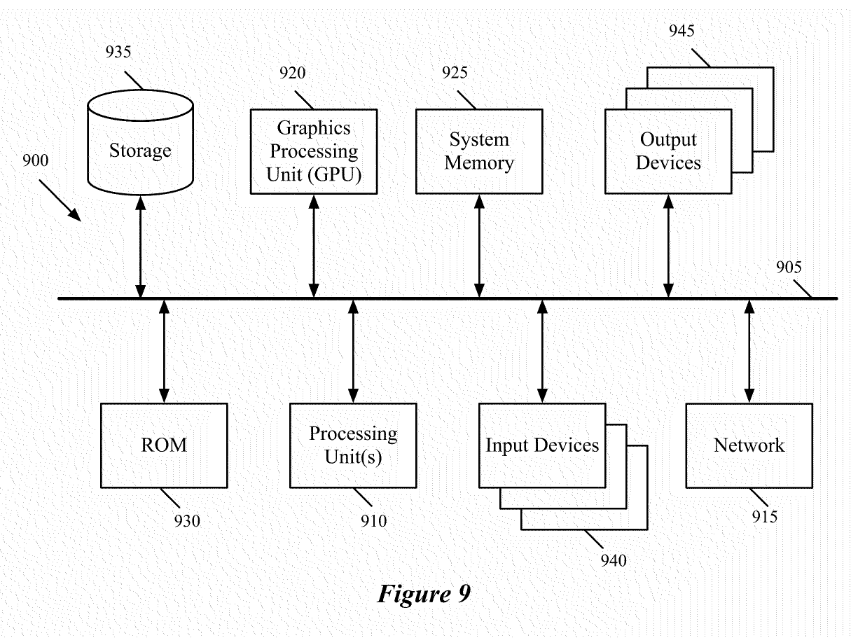

FIG. 9 conceptually illustrates an electronic system 900 with which some embodiments of the invention are implemented. The electronic system 900 may be a computer, phone, PDA, or any other sort of electronic device. Such an electronic system includes various types of computer readable media and interfaces for various other types of computer readable media. Electronic system 900 includes a bus 905, processing unit(s) 910, a graphics processing unit (GPU) 920, a system memory 925, a read-only memory 930, a permanent storage device 935, input devices 940, and output devices 945.

The bus 905 collectively represents all system, peripheral, and chipset buses that communicatively connect the numerous internal devices of the electronic system 900. For instance, the bus 905 communicatively connects the processing unit(s) 910 with the read-only memory 930, the GPU 920, the system memory 925, and the permanent storage device 935.

From these various memory units, the processing unit(s) 910 retrieve instructions to execute and data to process in order to execute the processes of the invention. The processing unit(s) may be a single processor or a multi-core processor in different embodiments. Some instructions are passed to and executed by the GPU 920. The GPU 920 can offload various computations or complement the image processing provided by the processing unit(s) 910.

The read-only-memory (ROM) 930 stores static data and instructions that are needed by the processing unit(s) 910 and other modules of the electronic system. The permanent storage device 935, on the other hand, is a read-and-write memory device. This device is a non-volatile memory unit that stores instructions and data even when the electronic system 900 is off. Some embodiments of the invention use a mass-storage device (such as a magnetic or optical disk and its corresponding disk drive) as the permanent storage device 935.

Other embodiments use a removable storage device (such as a floppy disk, flash drive, or ZIP® disk, and its corresponding disk drive) as the permanent storage device. Like the permanent storage device 935, the system memory 925 is a read-and-write memory device. However, unlike storage device 935, the system memory is a volatile read-and-write memory, such a random access memory. The system memory stores some of the instructions and data that the processor needs at runtime. In some embodiments, the invention's processes are stored in the system memory 925, the permanent storage device 935, and/or the read-only memory 930. For example, the various memory units include instructions for processing multimedia clips in accordance with some embodiments. From these various memory units, the processing unit(s) 910 retrieve instructions to execute and data to process in order to execute the processes of some embodiments.

The bus 905 also connects to the input and output devices 940 and 945. The input devices enable the user to communicate information and select commands to the electronic system. The input devices 940 include alphanumeric keyboards and pointing devices (also called “cursor control devices”). The output devices 945 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 9, bus 905 also couples electronic system 900 to a network 915 through a network adapter (not shown). In this manner, the computer can be a part of a network of computers (such as a local area network (“LAN”), a wide area network (“WAN”), or an Intranet, or a network of networks, such as the Internet. Any or all components of electronic system 900 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. In addition, FIG. 2 conceptually illustrates a process. The specific operations of this process may not be performed in the exact order shown and described. The specific operations may not be performed in one continuous series of operations, and different specific operations may be performed in different embodiments. Furthermore, the process could be implemented using several sub-processes, or as part of a larger macro process.

1. A system for generating price maps, the system comprising:
a data module for retrieving (1) data related to locations of real estate properties and (2) data related to prices of the real estate properties; and
a contour generator for generating a contour map comprising a plurality of contours based on the data related to the locations of the real estate properties and the data related to the prices of the real estate properties, each contour representing a set of real estate properties having prices within a defined range of values.

2. The system of claim 1, wherein at least two contours in the plurality of contours represent different defined ranges of values.

3. The system of claim 1, wherein contours representing different defined ranges of values have different appearances.

4. (canceled)

5. The system of claim 1, wherein contours representing the same defined ranges of values have the same appearances.

6. (canceled)

7. The system of claim 1, wherein contours representing real estate properties having high prices are indicated using a first set of colors, wherein contours representing real estate properties having low prices are indicated using a second set of colors.

8-13. (canceled)

14. The system of claim 1, wherein the real estate properties comprise apartment buildings, wherein the data related to the prices of real estate properties comprises, for each apartment building, an average price of apartments in the apartment building.

15. The system of claim 1 further comprising a contour adjustor for adjusting colors of the plurality of contours of the contour map after the contour generator generates the contour map.

16-29. (canceled)

30. A method of providing a graphical user interface (GUI) for real estate search, the method comprising:
providing a set of user interface (UI) tools for specifying a search query for real estate properties in a geographic region; and
providing a display area for displaying a map of the geographic region, the map comprising a plurality of regions, each region representing a set of real estate properties having values within a defined range of values.

31. The method of claim 30, wherein the display area is further for displaying the map overlaying a street map of the geographic region.

32. The method of claim 31, wherein the display area displays the map overlaying the street map by displaying a transparent version of the map overlaying the street map.

33. The method of claim 32, wherein the display area displays the map overlaying the street map by displaying a partially transparent version of the map overlaying the street map.

34. The method of claim 31 further providing a user interface (UI) control for adjusting a transparency level of the map for when the display area displays the map overlaying of the street map.

35. The method of claim 34, wherein the UI control comprises a slider control for specifying the transparency level of the one map, the slider control comprising a sliding region and a slider moveable along the sliding region, wherein different positions of the slider along the sliding region specifies different levels of transparency for the one map.

36. The method of claim 30, wherein the map is a contour map comprising a plurality of contour regions, each contour region representing (1) locations of real estate properties in the contour region and (2) a range of values of the real estate properties in the contour region.

37. (canceled)

38. (canceled)

39. The method of claim 30, wherein the display area is provided in response to a processing of the search query that is specified through the set of UI tools.

40-49. (canceled)

50. A method for generating price maps, the method comprising:
receiving a request for a map of a geographic region; and
in response to the request, generating the map of the geographic region, the map comprising a plurality of contours, each contour representing a contiguous set of locations that includes a set of real estate properties having values that fall within a defined range of values.

51. The method of claim 50, wherein the request is received from a real estate search engine.

52. The method of claim 51 further comprising transmitting the generated map of the geographic region to the real estate search engine for display in a graphical user interface (GUI).

53. The method of claim 51 further comprising storing in a storage the generated map of the geographic region for later use by the real estate search engine.

54. The method of claim 50, wherein generating the map of the geographic region comprises:
retrieving location data for a plurality of real estate properties, the location data representing locations of the plurality real estate properties in the geographic region;
retrieving value data for the plurality of real estate properties, the value data representing values of the real estate properties.

55. The method of claim 54, wherein the value data comprises for sale listing prices of the plurality of real estate properties.

56. The method of claim 54, wherein the value data comprises rental listing prices of the plurality of real estate properties.

57. The method of claim 54, wherein the value data comprises values of the plurality of real estate properties predicted based on a set of real estate models.

58. The method of claim 54, wherein the plurality of real estate properties comprise apartment buildings, wherein the value data comprises, for each apartment building, an average price of apartments in the apartment building.
